(19) United States
(12) Patent Application Publication
(10) Pub. No.: US 2003/0213139 A1
(43) Pub. Date: Nov. 20, 2003

(54) Sine jaw

(76) Inventor: Russell Leo Hachey, Waltham, MA (US)

Correspondence Address: RUSSELL LEO HACHEY SR, 16 PINE HILL CIRCLE, WALTHAM, MA, 02451, US

(21) Appl. No.: 10/051,922

(22) Filed: May 20, 2002

(51) Int. Cl. G01B 3/56

(52) U.S. Cl. 33/536

(57) ABSTRACT

MY INVENTION IS A MACHINE VISE JAW, MODIFIED WITH 0.063″ HOLES, TO ACCEPT 1/16 DOWEL PINS TO PROVIDE THE MACHINIST EASY SET UP TO MACHINE ANGLES IN AN “KURT ANGLE LOCK VISE”.

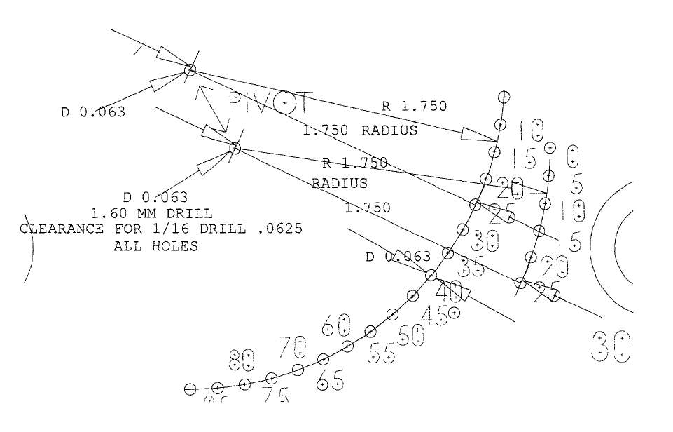

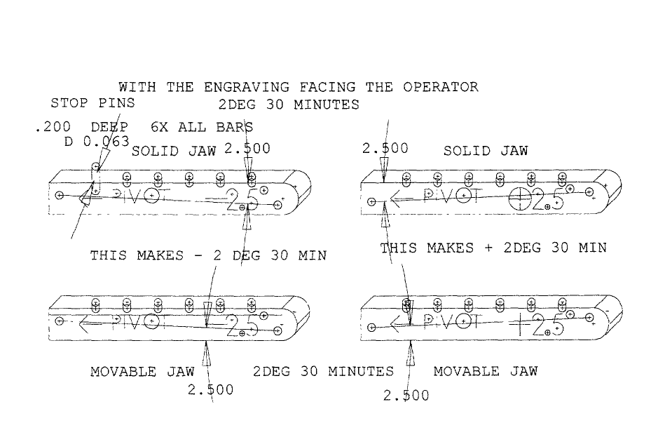

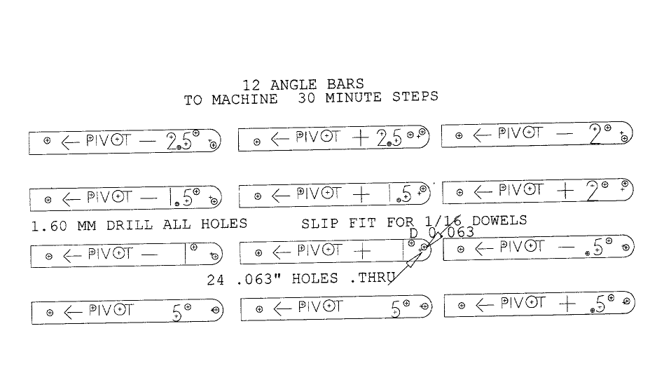

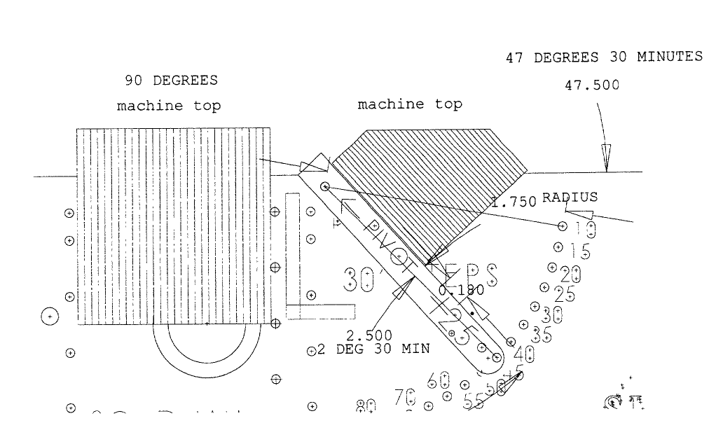

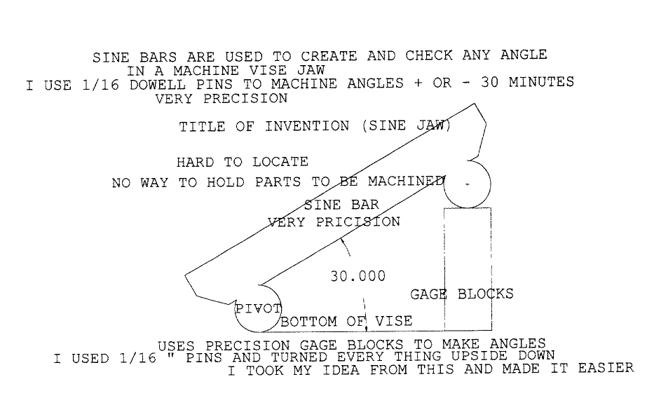

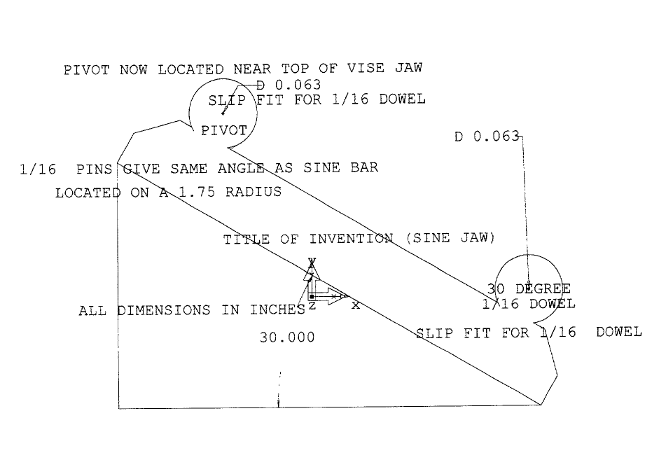

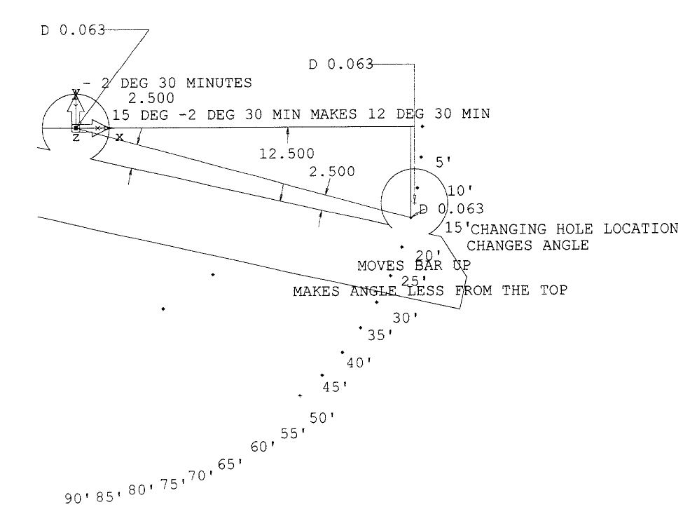

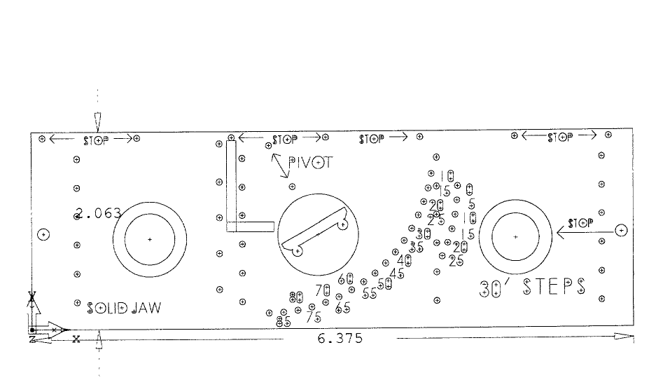

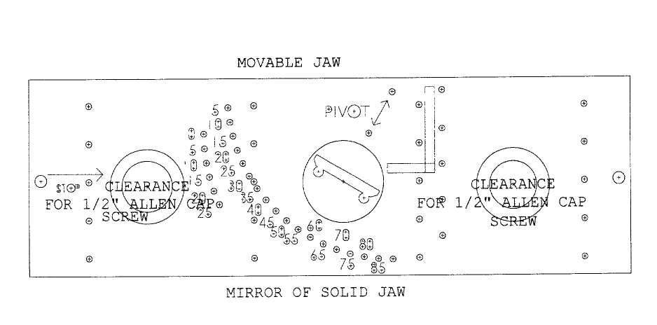

MY INVENTION IS A MACHINE VISE JAW MODIFIED WITH 0.063″ HOLES TO ACCEPT 1/16″ DOWEL PINS TO PROVIDE THE MACHINIST EASY SET UP TO MACHINE ANGLES IN AN “KURT ANGLE LOCK VISE” TWO 0.063″ HOLES ARE DRILLED FOR TWO PIVOT HOLES. A 1.75″ RADIUS CENTERED ON EACH PIVOT WITH 0.063″ HOLES IN 5 DEGREE INCREMENTS RADIALLY. THEY ARE ENGRAVED WITH NUMBERS TO TELL THE ANGLES THEY REPRESENT.

THE BOTTOM SET, IS TO MACHINE SMALLER ANGLES SO THE PARTS WILL SIT LOWER IN THE VISE AND HAVE MORE HOLDING AREA

SEE (drawings page 4).

THERE ARE 12 ANGLE BARS FOR VARIOUS ANGLES, RANGING FROM 30 MINUTE

TO 90 DEGREES IN 30 MINUTE STEPS (see drawings page 5 and 6).

FOR A DEMONSTRATON OF HOW TO MACHINE BLOCKS (see drawing page 7).

RELATED ITEMS (see drawings page 8, 9, 10, 11 and 12).

What I claim:

1. I AM A RETIRED MACHINIST. I HAVE WORKED IN MACHINE SHOPS FOR OVER 40 YEARS. IN THAT TIME HAVE SPENT THOUSANDS OF HOURS LOOKING FOR PARALLELS, THAT ARE PAIRS AND THE RIGHT HEIGHT, LOOKING FOR VISE STOPS, AND SPRINGS TO KEEP THE PARALLELS APART. I SAID TO MYSELF THERE MUST BE A EASIER WAY, SO I DESIGNED THIS MULTIPURPOSE VISE JAW. THIS IS USED ON VERTICAL MILLING MACHINES. “KURT ANGLE LOCK VISES”. I CALL IT A SINE/JAW AND IT USES SMALL ANGLE/BARS. SEE LIST OF SEVEN DRAWINGS FOR EXPLANTIONS ON HOW THEY WORK.
